(19) United States
(12) Patent Application Publication
(10) Pub. No.: US 2015/0362631 A1
(43) Pub. Date: Dec. 17, 2015

(54) OPTICAL MATERIAL, OPTICAL ELEMENT AND HYBRID OPTICAL ELEMENT

(71) Applicant: Panasonic Intellectual Property Management Co., Ltd., Osaka (JP)

(72) Inventor: Iwao UENO, Kyoto (JP)

(21) Appl. No.: 14/834,982

(22) Filed: Aug. 25, 2015

Related U.S. Application Data
(63) Continuation of application No. PCT/JP2014/000978, filed on Feb. 25, 2014.

(30) Foreign Application Priority Data
Feb. 27, 2013 (JP) 2013-036571

(51) Int. Cl. G02B 1/04

(52) U.S. Cl. CPC G02B 1/041

(57) ABSTRACT

An optical material is composed of a resin material and inorganic fine particles dispersed in the resin material. Each of the inorganic fine particles has a core and a shell formed so as to cover a part of a surface of the core. The core is formed of an oxide of at least one selected from Si, Ti, Zn, Al, B, Y, Mg, Ba, Ca, Sr, Ni, Cu, In, and Sn. The shell is formed of an oxide of at least one selected from Si, Ti, Zn, Al, B, Y, Mg, Ba, Ca, Sr, Ni, Cu, In, and Sn, which is different from the oxide forming the core. The particle diameter of the oxide forming the shell is smaller than the particle diameter of the oxide forming the core. The shell is formed as crystalline fine particles.

### CROSS-REFERENCE TO RELATED APPLICATION

This application is a Continuation of International Application No. PCT/JP2014/000978, filed on Feb. 25, 2014, which in turn claims the benefit of Japanese Application No. 2013-036571, filed on Feb. 27, 2013, the disclosures of which Applications are incorporated by reference herein.

### BACKGROUND

1. Field

The present disclosure relates to optical materials, optical elements, and hybrid optical elements.

2. Description of the Related Art

High-precision imaging devices such as digital still cameras adopt optical systems having a plurality of lens units, and various optical materials having different optical constants such as refractive indices, Abbe numbers, partial dispersion ratios are required. Therefore, optical glass materials and optical resin materials having various optical constants have been developed and used. In particular, optical glass materials having high refractive indices and high Abbe numbers have been frequently used in many imaging devices to improve optical performances thereof.

On the other hand, technological development has been actively conducted for synthesizing moldable nano-composite materials having optical constants which could not be achieved by conventional resin materials, by dispersing nano-fine particles having specific optical constants in resin materials. Such nano-composite materials having optical constants which could not be achieved even by optical glass are expected as substitutions for optical glass having specific optical constants such as a high refractive index and a high Abbe number, or optical glass having poor durability.

Among the nano-composite materials, a nano-composite material having a high refractive index has been actively developed. Japanese Laid-Open Patent Publication No. 2006-089706 discloses a material using yttrium oxide (Y₂O₃) as inorganic fine particles, and Japanese Laid-Open Patent Publication No. 2008-203821 discloses a material containing Al, Si, Ti, Zr, Ga, La, or the like.

### SUMMARY

The present disclosure provides an optical material which allows free control of its optical constants in a wide range, and an optical element and a hybrid optical element which are formed of the optical material.

The novel concepts disclosed herein were achieved in order to solve the foregoing problems in the related art, and herein is disclosed:

an optical material comprising a resin material and inorganic fine particles dispersed in the resin material, wherein

each of the inorganic fine particles has a core and a shell formed so as to cover a part of a surface of the core,

the core is formed of an oxide of at least one selected from Si, Ti, Zn, Al, B, Y, Mg, Ba, Ca, Sr, Ni, Cu, In, and Sn,

the shell is formed of an oxide of at least one selected from Si, Ti, Zn, Al, B, Y, Mg, Ba, Ca, Sr, Ni, Cu, In, and Sn, the oxide forming the shell being different from the oxide forming the core,

a particle diameter of the oxide forming the shell is smaller than a particle diameter of the oxide forming the core, and

the shell is formed as crystalline fine particles.

The novel concepts disclosed herein were achieved in order to solve the foregoing problems in the related art, and herein is disclosed:

an optical element which is formed of an optical material comprising a resin material and inorganic fine particles dispersed in the resin material, wherein

each of the inorganic fine particles has a core and a shell formed so as to cover a part of a surface of the core,

the core is formed of an oxide of at least one selected from Si, Ti, Zn, Al, B, Y, Mg, Ba, Ca, Sr, Ni, Cu, In, and Sn,

the shell is formed of an oxide of at least one selected from Si, Ti, Zn, Al, B, Y, Mg, Ba, Ca, Sr, Ni, Cu, In, and Sn, the oxide forming the shell being different from the oxide forming the core,

a particle diameter of the oxide forming the shell is smaller than a particle diameter of the oxide forming the core, and

the shell is formed as crystalline fine particles.

The novel concepts disclosed herein were achieved in order to solve the foregoing problems in the related art, and herein is disclosed:

a hybrid optical element comprising a first optical element and a second optical element disposed on an optical surface of the first optical element, wherein

the second optical element is an optical element foamed of an optical material composed of a resin material and inorganic fine particles dispersed in the resin material, wherein

each of the inorganic fine particles has a core and a shell formed so as to cover a part of a surface of the core,

the core is formed of an oxide of at least one selected from Si, Ti, Zn, Al, B, Y, Mg, Ba, Ca, Sr, Ni, Cu, In, and Sn,

the shell is formed of an oxide of at least one selected from Si, Ti, Zn, Al, B, Y, Mg, Ba, Ca, Sr, Ni, Cu, In, and Sn, the oxide forming the shell being different from the oxide forming the core,

a particle diameter of the oxide forming the shell is smaller than a particle diameter of the oxide forming the core, and

the shell is formed as crystalline fine particles.

The optical material according to the present disclosure, which is a composite material in which inorganic fine particles having a core-shell structure are dispersed in a resin material, allows free control of its optical constants in a wide range.

### BRIEF DESCRIPTION OF THE DRAWINGS

This and other objects and features of the present disclosure will become clear from the following description, taken in conjunction with the exemplary embodiments with reference to the accompanied drawings in which:

FIG. 1 is a schematic diagram showing a composite material according to Embodiment 1, wherein (a) is a schematic cross-sectional view showing a configuration of the composite material, and (b) is a schematic cross-sectional view showing a core-shell structure of an inorganic fine particle;

FIG. 2 is a graph explaining an effective particle diameter of inorganic fine particles;

FIG. 3 shows a plot showing the relationship between the refractive index and the Abbe number of SiO₂ according to Embodiment 1;

FIG. 4 shows a plot showing the relationship between the partial dispersion ratio and the Abbe number of SiO₂, and a normal dispersion line, according to Embodiment 1;

FIG. 5 is a transmission electron microscope photograph of SiO₂ fine particles;

FIG. 6 is a transmission electron microscope photograph of inorganic fine particles having a core-shell structure in which the core is SiO₂ and the shell is TiO₂;

FIG. 7 is a schematic structural diagram showing a hybrid lens according to Embodiment 2;

FIG. 8 shows plots showing the relationship between the refractive indices and the Abbe numbers of various materials according to Examples 1 to 8 and Comparative Examples 1 and 2;

FIG. 9 shows plots showing the relationship between the partial dispersion ratios and the Abbe numbers of various materials according to Examples 1 to 8 and Comparative Examples 1 and 2, and a normal dispersion line;

FIG. 10 shows plots showing the relationship between the refractive indices and the Abbe numbers of various materials according to Examples 9 to 14 and Comparative Examples 1 and 3; and

FIG. 11 shows plots showing the relationship between the partial dispersion ratios and the Abbe numbers of various materials according to Examples 9 to 14 and Comparative Examples 1 and 3, and a normal dispersion line.

### DETAILED DESCRIPTION

Hereinafter, embodiments will be described with reference to the drawings as appropriate. However, descriptions more detailed than necessary may be omitted. For example, detailed description of already well known matters or description of substantially identical configurations may be omitted. This is intended to avoid redundancy in the description below, and to facilitate understanding of those skilled in the art.

It should be noted that the applicant provides the attached drawings and the following description so that those skilled in the art can fully understand this disclosure. Therefore, the drawings and description are not intended to limit the subject defined by the claims.

### Embodiment 1

Hereinafter, Embodiment 1 is described with reference to the drawings.

[1. Composite Material]

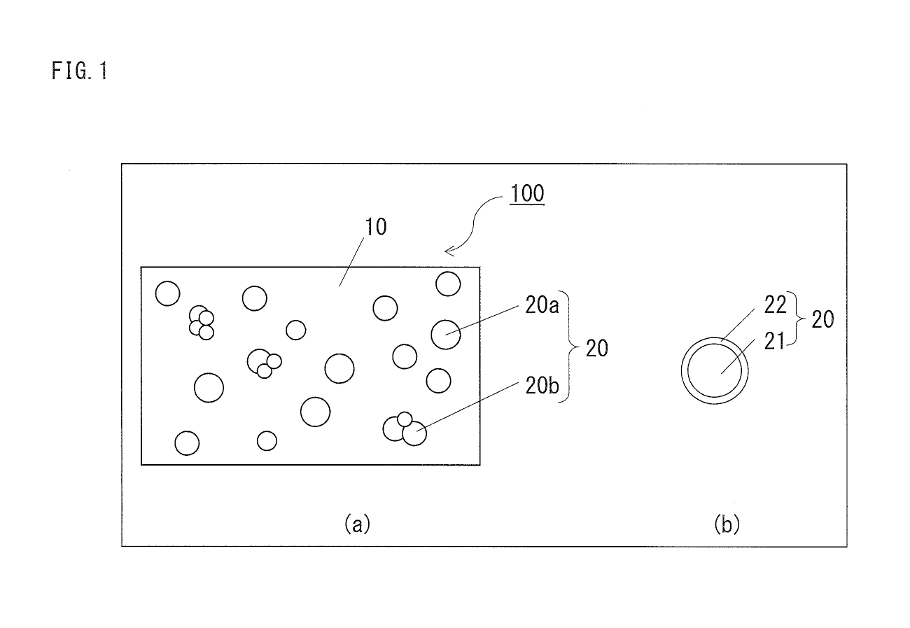

FIG. 1 is a schematic diagram showing a composite material according to Embodiment 1, wherein (a) is a schematic cross-sectional view showing a configuration of the composite material, and (b) is a schematic cross-sectional view showing a core-shell structure of an inorganic fine particle.

As shown in FIG. 1(a), a composite material 100 according to Embodiment 1, which is an example of an optical material according to the present disclosure, is composed of a resin material 10 as a matrix material, and inorganic fine particles 20 dispersed in the resin material 10. As shown in FIG. 1(b), each inorganic fine particle 20 is composed of a core 21 and a shell 22 formed so as to cover the surface of the core 21. The shell 22 may cover the entire surface of the core 21, or may cover a part of the surface of the core 21. The shell 22 may be formed in a film shape, or may be formed of a plurality of fine particles densely aggregated.

[2. Inorganic Fine Particles]

The core 21 of each inorganic fine particle 20 is formed of at least one selected from SiO₂, TiO₂, ZnO, Al₂O₃, B₂O₃, Y₂O₃, MgO, BaO, CaO, SrO, NiO, CuO, BaTiO₃, Indium tin oxide (hereinafter referred to as ITO), SnO₂, and zeolite. Among these, SiO₂ and ZnO are beneficial as materials of the core 21 because SiO₂ and ZnO each can provide an optical material that allows more free control of its optical constants in a wide range.

A core-shell structure in which the core is formed of SiO₂ is also referred to as an SiO₂ core-shell structure.

The shell 22 of each inorganic fine particle 20 is beneficially formed of oxide(s) of at least one selected from Si, Ti, Zn, Al, B, Y, Mg, Ba, Ca, Sr, Ni, Cu, In, and Sn. Among these, oxide(s) of at least one selected from Y, Zn, Ti, In, and Sn, that is, Y₂O₃, ZnO, TiO₂, and ITO, are beneficial as materials of the shell 22 because Y₂O₃, ZnO, TiO₂, and ITO can provide an optical material that allows more free control of its optical constants in a wide range.

The ratio of the material forming the core to the material forming the shell in the core-shell structure is not particularly limited, and may be appropriately adjusted according to the combination of used materials so that a resultant optical material has the effect of freely controlling its optical constants in a wide range. For example, the ratio of the material forming the shell is beneficially about 1% to 20% by weight, and more beneficially about 2% to 18% by weight, to the material forming the core.

The inorganic fine particles 20 may be either aggregated particles or non-aggregated particles. Generally, the inorganic fine particles 20 include primary particles 20a and secondary particles 20b which are aggregates of the primary particles 20a. The dispersion state of the inorganic fine particles 20 is not particularly limited because desired effects can be obtained as long as the inorganic fine particles 20 are present in the resin material 10 serving as a matrix material. However, it is beneficial that the inorganic fine particles 20 are uniformly dispersed in the resin material 10. As used herein, “the inorganic fine particles 20 uniformly dispersed in the resin material 10” means that the primary particles 20a and the secondary particles 20b of the inorganic fine particles 20 are substantially uniformly dispersed in the composite material 100 without being localized in any particular region in the composite material 100. It is beneficial that the particles have good dispersion property in order to prevent light transmittance of the optical material from being degraded. For this purpose, it is beneficial that the inorganic fine particles 20 consist of only the primary particles 20a.

The particle diameter of the inorganic fine particles 20 is an essential factor in ensuring the light transmittance of the composite material 100 in which the inorganic fine particles 20 having the SiO₂ core-shell structure are dispersed in the resin material 10. When the particle diameter of the inorganic fine particles 20 is sufficiently smaller than the wavelength of light, the composite material 100 in which the inorganic fine particles 20 are dispersed in the resin material 10 can be regarded as a homogeneous medium without variations in the refractive index. Therefore, it is beneficial that the particle diameter of the inorganic fine particles 20 is equal to or smaller than the wavelength of visible light. Since visible light has wavelengths ranging from 400 nm to 700 nm, it is beneficial that the maximum particle diameter of the inorganic fine particles 20 is 400 nm or less. It is noted that the maximum particle diameter of the inorganic fine particles 20 can be obtained by taking a scanning electron microscope photograph of the inorganic fine particles 20 and measuring the particle diameter of the largest inorganic fine particle 20 (the secondary particle diameter if the largest particle is a secondary particle).

When the particle diameter of the inorganic fine particles 20 is larger than one fourth of the wavelength of light, the light transmittance of the composite material 100 may be degraded by Rayleigh scattering. Therefore, it is beneficial that the effective particle diameter of the inorganic fine particles 20 is 100 nm or less in order to achieve high light transmittance in the visible light region. However, when the effective particle diameter of the inorganic fine particles 20 is less than 1 nm, fluorescence may occur if the inorganic fine particles 20 are made of a material that exhibits quantum effects. This fluorescence may affect the properties of an optical component fanned of the composite material 100.

From the viewpoints described above, the effective particle diameter of the inorganic fine particles 20 is beneficially in the range from 1 nm to 100 nm, and more beneficially in the range from 1 nm to 50 nm. In particular, it is further beneficial that the effective particle diameter of the inorganic fine particles 20 is 20 nm or less because the negative effect of Rayleigh scattering is very small while the light transmittance of the composite material 100 is particularly high.

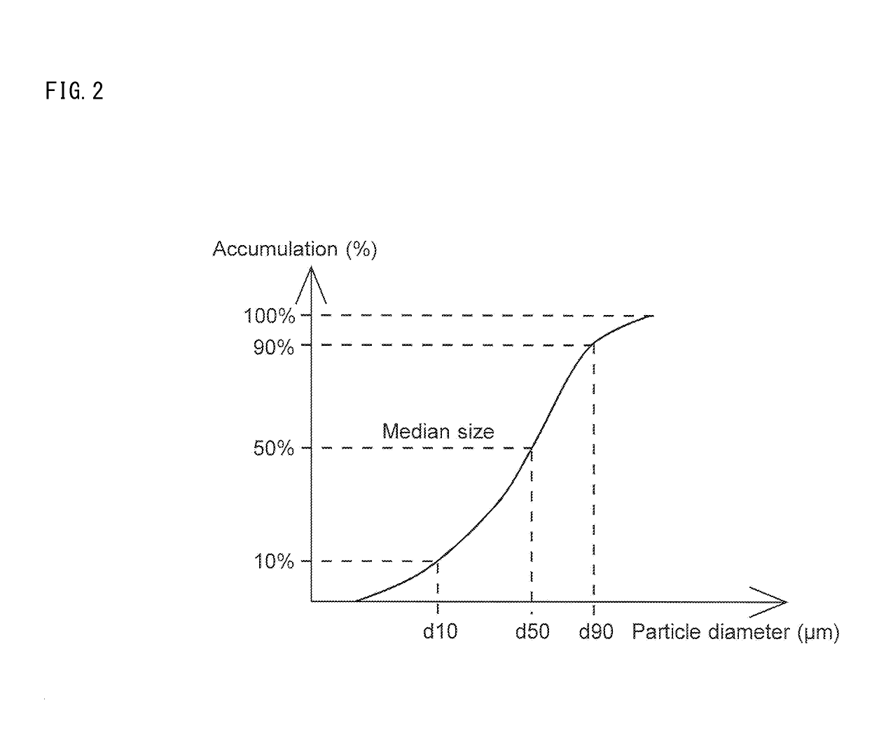

The effective particle diameter of the inorganic fine particles is described with reference to FIG. 2. In FIG. 2, the horizontal axis represents the particle diameters of the inorganic fine particles, and the vertical axis represents accumulation of the inorganic fine particles with respect to the respective particle diameters represented on the horizontal axis. When the inorganic fine particles are aggregated, the particle diameters on the horizontal axis represent the diameters of the secondary particles in an aggregated state. The effective particle diameter refers to the median particle diameter (median size: d50) corresponding to accumulation of 50% in the graph showing the accumulation distribution with respect to the respective particle diameters of the inorganic fine particles as shown in FIG. 2. In order to improve the accuracy of the effective particle diameter, it is beneficial, for example, to take a scanning electron microscope photograph of the inorganic fine particles and measure the particle diameters of at least 200 of the inorganic fine particles.

As described above, the composite material 100 according to Embodiment 1 is fotmed by dispersing the inorganic fine particles 20 having the SiO₂ core-shell structure in the resin material 10. As described later, the composite material 100 thus formed allows easy control of its optical properties in a wider range, as compared to the case of using inorganic fine particles formed of SiO₂ alone.

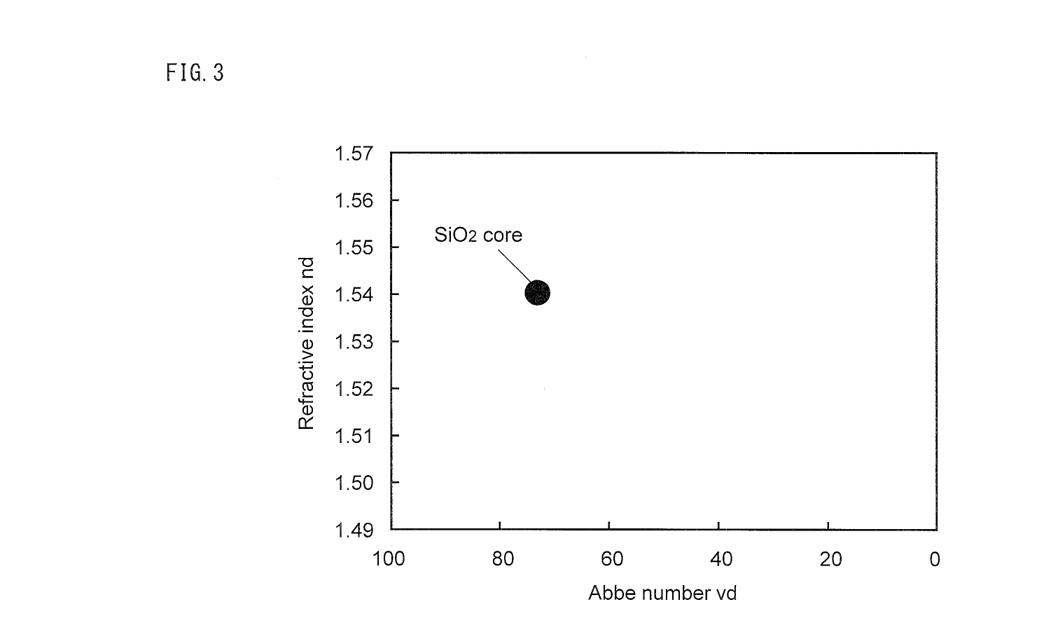

FIG. 3 is a graph showing the relationship between the refractive index nd of SiO₂ to the d-line (wavelength of 587.6 nm) and the Abbe number νd of SiO₂ to the d-line, which represents the wavelength dispersion property. The Abbe number νd is a value defined by the following formula (1):

νd=(nd−1)/(nF−nC) (1)

where

nd is the refractive index of the material to the d-line,

nF is the refractive index of the material to the F-line (wavelength of 486.1 nm), and

nC is the refractive index of the material to the C-line (wavelength of 656.3 nm).

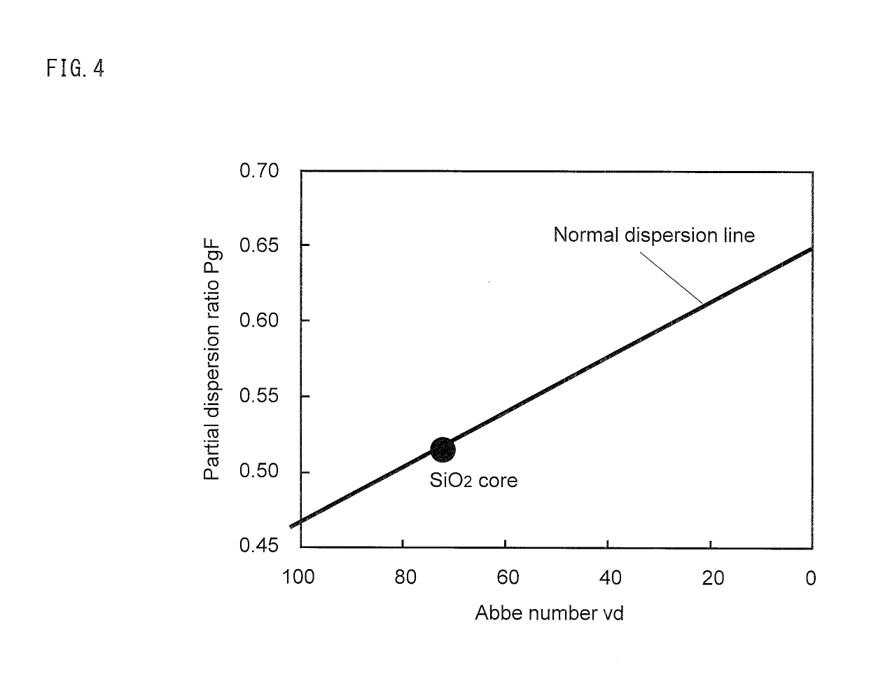

FIG. 4 is a graph showing: the relationship between the partial dispersion ratio PgF of SiO₂, which represents the dispersion properties at the g-line (wavelength of 435.8 nm) and the F-line, and the Abbe number νd of SiO₂ to the d-line, which represents the wavelength dispersion property; and a normal dispersion line. The partial dispersion ratio PgF is a value defined by the following formula (2):

PgF=(ng−nF)/(nF−nC) (2)

where

ng is the refractive index of the material to the g-line,

nF is the refractive index of the material to the F-line, and

nC is the refractive index of the material to the C-line.

The anomalous dispersion property ΔPgF is a deviation of the PgF of each material from a point on the reference line of normal partial dispersion glass corresponding to the νd of the material. In the present disclosure, the ΔPgF is calculated using a straight line (normal dispersion line in FIG. 4) passing through the coordinates of glass type C7 (nd of 1.51, νd of 60.5, and PgF of 0.54) and glass type F2 (nd of 1.62, νd of 36.3, and PgF of 0.58) as the reference line of the normal partial dispersion glass, based on the standards of HOYA Corporation.

As shown in FIGS. 3 and 4, SiO₂ has the following optical properties: refractive index nd of 1.54; Abbe number νd of 69.6; and partial dispersion ratio PgF of 0.53. The anomalous dispersion property ΔPgF of SiO₂ is 0.00, and SiO₂ is an extremely general material existing on the normal dispersion line. The composite material using the inorganic fine particles having the SiO₂ core-shell structure in which SiO₂ is used as the core and ZnO, TiO₂, ITO, Y₂O₃, Al₂O₃, SnO₂, ZrO₂, or the like is used as the shell, allows control, in a wide range, of its optical properties such as the Abbe number, the refractive index, and the partial dispersion ratio, and consequently, the property of extremely great anomalous dispersion is imparted to the composite material. Therefore, the composite material using the inorganic fine particles having the SiO₂ core-shell structure can offer greater flexibility in designing optical components as compared to the conventional materials.

In addition, by increasing the thickness of the shell in the core-shell structure (in the later-described examples, the ratio of the material forming the shell to the material forming the core is increased), it is possible to control the optical properties in a wider range.

[3. Resin Material]

As the resin material 10, resins having high light transmittance, selected from resins such as thermoplastic resins, thermosetting resins, and energy ray-curable resins, can be used. For example, acrylic resins; methacrylic resins such as polymethyl methacrylate; epoxy resins; polyester resins such as polyethylene terephthalate, polybutylene terephthalate, and polycaprolactone; polystyrene resins such as polystyrene; olefin resins such as polypropylene; polyamide resins such as nylon; polyimide resins such as polyimide and polyether imide; polyvinyl alcohol; butyral resins; vinyl acetate resins; alicyclic polyolefin resins; silicone resins; and amorphous fluororesins may be used. Engineering plastics such as polycarbonate, liquid crystal polymers, polyphenylene ether, polysulfone, polyether sulfone, polyarylate, and amorphous polyolefin also may be used. Mixtures and copolymers of these resins also may be used. Resins obtained by modifying these resins also may be used.

Among these, acrylic resins, methacrylic resins, epoxy resins, polyimide resins, butyral resins, alicyclic polyolefin resins, and polycarbonate are beneficial because these resins have high transparency and good moldability. These resins can have refractive indices nd ranging from 1.4 to 1.7 by selecting a specific molecular skeleton.

The Abbe number νdₘ of the resin material 10 to the d-line is not particularly limited. Needless to say, the Abbe number νd_{COM} of the composite material 100 to the d-line, which is obtained by dispersing the inorganic fine particles 20, increases as the Abbe number νdₘ of the resin material 10 serving as a matrix material increases. In particular, it is beneficial to use a resin having an Abbe number νdₘ of 45 or more as the resin material 10 because the use of such a resin makes it possible to obtain a composite material having optical properties, such as an Abbe number νd_{COM} of 40 or more, enough for use in optical components such as lenses. Examples of the resin having an Abbe number νdₘ of 45 or more include: alicyclic polyolefin resins having an alicyclic hydrocarbon group in the skeleton; silicone resins having a siloxane structure; and amorphous fluororesins having a fluorine atom in the main chain. However, the resin having an Abbe number νdₘ of 45 or more is not limited to these resins.

[4. Optical Properties of Composite Material]

The refractive index of the composite material 100 can be estimated from the refractive indices of the inorganic fine particles 20 and the resin material 10, for example, based on the Maxwell-Garnett theory represented by the following formula (3). It is also possible to estimate the refractive indices of the composite material 100 to the d-line, the F-line, and the C-line from the following formula (3), and further estimate the Abbe number νd of the composite material 100 from the above formula (1). Conversely, the weight ratio between the resin material 10 and the inorganic fine particles 20 may be determined from the estimation based on this theory.

nλ_{COM}²=[{nλₚ²+2nλₘ²+2P(nλₚ²−nλₘ²)}/{nλₚ²+2nλₘ²−P(nλₚ²−nλₘ²)}]×nλₘ² (3)

where

nλ_{COM} is the average refractive index of the composite material 100 at a specific wavelength λ,

nλₚ is the refractive index of the inorganic fine particles 20 at the specific wavelength λ,

nλₘ is the refractive index of the resin material 10 at the specific wavelength λ, and

P is the volume ratio of the inorganic fine particles 20 to the composite material 100 as a whole.

In the case where the inorganic fine particles 20 absorb light or where the inorganic fine particles 20 contain metal, complex refractive indices are used as the refractive indices in the formula (3) for calculation. The formula (3) holds in the case of nλₚ≧nλₘ, and in the case of nλₚ<nλₘ, the refractive index of the composite material 100 is estimated by using the following formula (4):

nλ_{COM}²=[{nλₘ²+2nλₚ²+2(1−P)(nλₘ²−nλₚ²)}/{nλₘ²+2nλₚ²−(1−P)(nλₘ²−nλₚ²)}]×nλₚ² (4)

where nλ_{COM}, nλₚ, nλₘ, and P are the same as those of the formula (3).

The actual refractive index of the composite material 100 can be evaluated by film-forming or molding the prepared composite material 100 into a shape suitable for a measurement method to be used, and actually measuring the formed or molded product by the method. The method is, for example, a spectroscopic measurement method such as an ellipsometric method, an Abeles method, an optical waveguide method or a spectral reflectance method, or a prism-coupler method.

A description is given of the optical properties of the composite material 100 estimated by using the above-mentioned Maxwell-Garnett theory, and the content of the inorganic fine particles 20 in the composite material 100. When the content of the inorganic fine particles 20 in the composite material 100 is too small, the effect of adjustment of the optical properties due to the inorganic fine particles 20 may not be sufficiently obtained. Therefore, the content of the inorganic fine particles 20 is beneficially 1% by weight or more, more beneficially 5% by weight or more, and further beneficially 10% by weight or more, with respect to the total weight of the composite material (optical material) 100. On the other hand, when the content of the inorganic fine particles 20 in the composite material 100 is too large, the fluidity of the composite material 100 decreases, which may make it difficult to mold the composite material 100 into optical elements, or even to add the inorganic fine particles 20 into the resin material 10. Thus, the content of the inorganic fine particles 20 is beneficially 80% by weight or less, more beneficially 60% by weight or less, and further beneficially 40% by weight or less, with respect to the total weight of the composite material 100.

[5. Production Method of Composite Material]

First, a method for forming the inorganic fine particles 20 is described. The core 21 of the inorganic fine particles 20 can be formed by a liquid phase method such as a coprecipitation method, a sol-gel method, or metal complex decomposition or a vapor phase method. Alternatively, the core 21 may be formed by grinding a bulk into fine particles by a grinding method using a ball mill or a bead mill. The material of the core 21 is at least one selected from SiO₂, TiO₂, ZnO, Al₂O₃, B₂O₃, Y₂O₃, MgO, BaO, CaO, SrO, NiO, CuO, BaTiO₃, ITO, SnO₂, and zeolite.

An organic metal complex solution may be used for forming the shell 22 of the inorganic fine particles 20. For example, an organic metal complex solution obtained by diluting a material of the shell 22 which is oxide(s) of at least one selected from Si, Ti, Zn, Al, B, Y, Mg, Ba, Ca, Sr, Ni, Cu, In, and Sn, with toluene, benzene, xylene, alcohol, or the like, is mixed with the core 21, and then excessive solution is removed by using a centrifuge to obtain a solid content. Then, the solid content is subjected to heat treatment in the atmosphere, thereby obtaining the inorganic fine particles 20 having the core-shell structure in which at least a part of the surface of the core 21 is covered with the shell 22. If the heat treatment is performed at an extremely high temperature, grain growth of the core 21 tends to take place. On the other hand, if the heat treatment is performed at an extremely low temperature, thermal decomposition of the organic substance tends to be difficult. Therefore, the heat treatment is performed for about 30 to 60 minutes, beneficially at about 200 to 600° C., and more beneficially, at about 200 to 400° C.

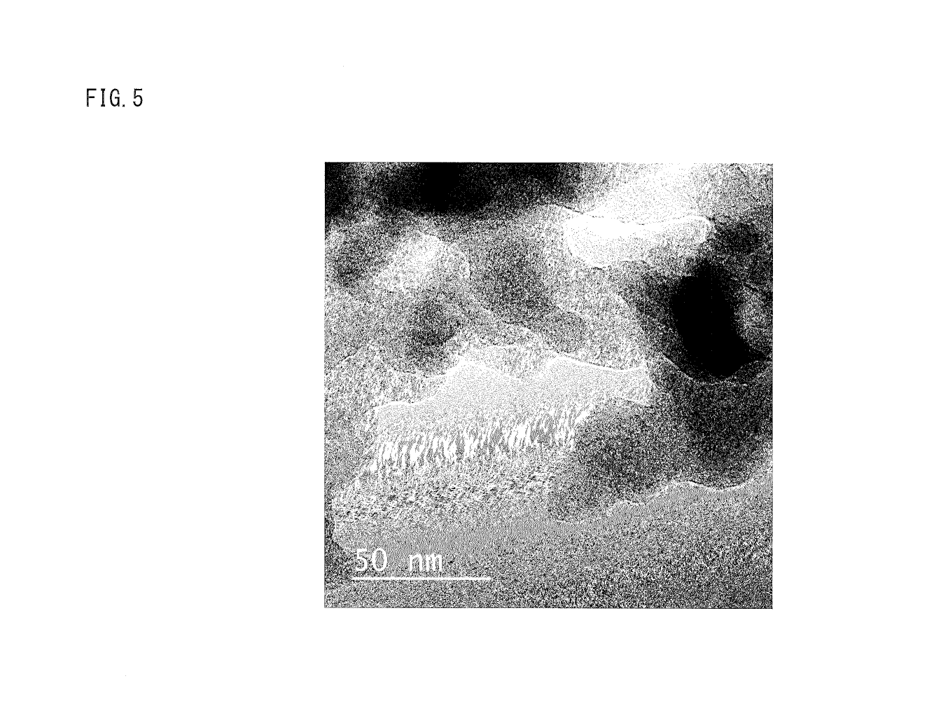

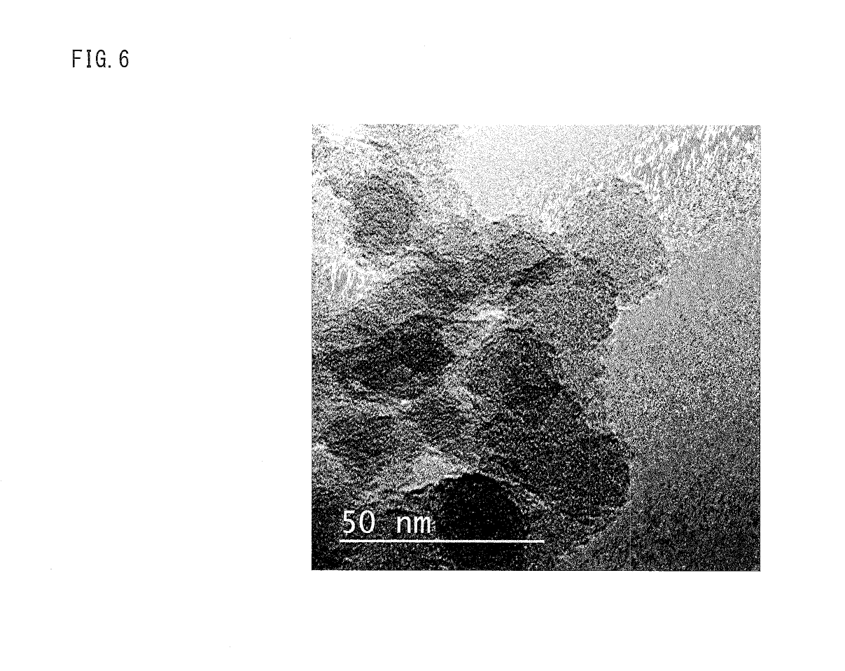

FIG. 5 is a transmission electron microscope photograph of SiO₂ fine particles. FIG. 6 is a transmission electron microscope photograph of inorganic fine particles having a core-shell structure in which the core is SiO₂ and the shell is TiO₂.

As shown in FIGS. 5 and 6, in contrast to the photograph of the SiO₂ fine particles shown in FIG. 5, in the photograph of the inorganic fine particles having the core-shell structure shown in FIG. 6, it is observed that minute asperities are remarkably present on the surface. That is, it is observed in the photograph of FIG. 6 that TiO₂ particles each having a particle diameter of 1 to 3 nm are densely formed on the surface of each SiO₂ particle having a particle diameter of several 10 nm. Although it has been supposed that the shell is formed as an amorphous film, it is found that the shell is formed as crystalline fine particles.

Next, a method for preparing the composite material 100 is described. There is no particular limitation on the method for preparing the composite material 100 by dispersing the inorganic fine particles 20 formed by the above-described method in the resin material 10 serving as a matrix material. The composite material 100 may be prepared by a physical method or by a chemical method. For example, the composite material 100 can be prepared by any of the following Methods (1) to (4).

Method (1): A resin or a solution in which a resin is dissolved is mechanically and/or physically mixed with inorganic fine particles.

Method (2): A monomer, an oligomer, or the like as a raw material of a resin is mechanically and/or physically mixed with inorganic fine particles to obtain a mixture, and then the monomer, the oligomer, or the like as a raw material of a resin is polymerized.

Method (3): A resin or a solution in which a resin is dissolved is mixed with a raw material of inorganic fine particles, and then the raw material of the inorganic fine particles is reacted so as to form the inorganic fine particles in the resin.

Method (4): After a monomer, an oligomer, or the like as a raw material of a resin is mixed with a raw material of inorganic fine particles, a step of reacting the raw material of inorganic fine particles so as to form the inorganic fine particles and a step of polymerizing the monomer, the oligomer, or the like as a raw material of a resin so as to synthesize the resin are performed.

The above methods (1) and (2) are advantageous in that various pre-formed inorganic fine particles can be used and that composite materials can be prepared by a general-purpose dispersing machine. On the other hand, the above methods (3) and (4) require chemical reactions, and therefore, usable materials are limited to some extent. However, since the raw materials are mixed at the molecular level in the methods (3) and (4), these methods are advantageous in that the dispersion property of the inorganic fine particles can be enhanced.

In the above methods, there is no particular limitation on the order of mixing the inorganic fine particles or the raw material of the inorganic fine particles with a resin, or a monomer, an oligomer, or the like as the raw material of the resin. A desirable order can be selected as appropriate. For example, the resin or the raw material of the resin or a solution in which the resin or the raw material of the resin is dissolved may be added to a solution in which inorganic fine particles having a primary particle diameter substantially in the range from 1 nm to 100 nm are dispersed to mix them mechanically and/or physically. The production method of the composite material 100 is not particularly limited as long as the effect of the present disclosure can be achieved.

The composite material 100 may contain components other than the inorganic fine particles 20 and the resin material 10 serving as a matrix material, as long as the effect of the present disclosure can be achieved. For example, a dispersant or a surfactant that improves the dispersion property of the inorganic fine particles 20 in the resin material 10, or a dye or a pigment that absorbs electromagnetic waves within a specific range of wavelengths may coexist in the composite material 100, although not shown in the drawings.

There is no particular limitation on the method for producing an optical element such as a lens from the composite material 100, and known techniques may be adopted. For example, the composite material 100 may be filled in a mold having a shape corresponding to an optical element such as a lens, and cured with an energy ray such as an ultraviolet ray being applied thereto, thereby to form an optical element such as a lens.

### Embodiment 2

Hereinafter, Embodiment 2 is described with reference to the drawings.

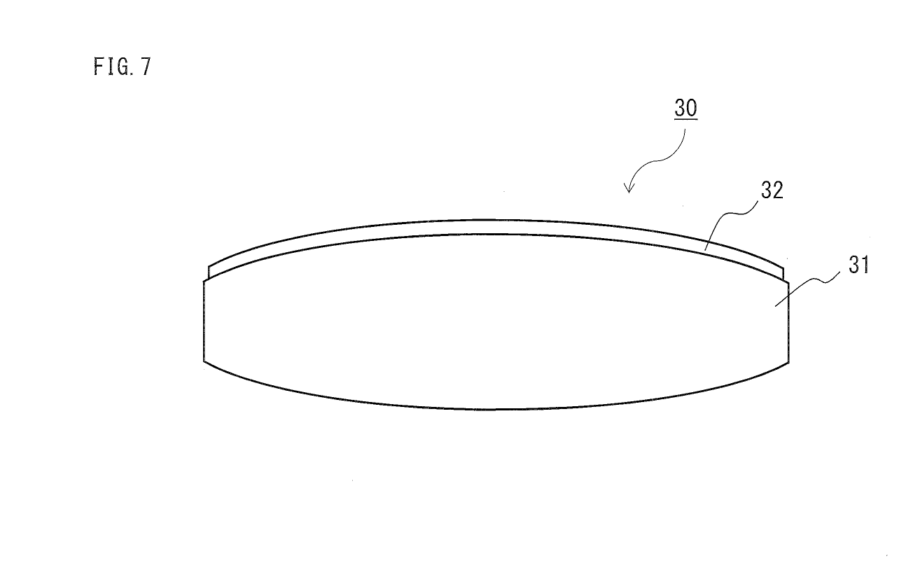

FIG. 7 is a schematic structural diagram showing a hybrid lens according to Embodiment 2. The hybrid lens 30 is composed of a first lens 31 serving as a base, and a second lens 32 disposed on an optical surface of the first lens 31. The hybrid lens 30 is an example of a hybrid optical element.

The first lens 31 is a first optical element, and an example of a glass lens. The first lens 31 is formed of a glass material, and is a bi-convex lens.

The second lens 32 is a second optical element, and an example of a resin lens. The second lens 32 is formed of a composite material, and the composite material 100 according to Embodiment 1 is used as the composite material.

The both surfaces of the hybrid lens 30 shown in FIG. 7 are convex, but at least one of the surfaces may be concave. There is no particular limitation on the shape of the hybrid lens 30. The hybrid lens 30 is designed as appropriate for the desired optical properties. In the hybrid lens 30 shown in FIG. 7, the second lens 32 is disposed on one of optical surfaces of the first lens 31, but the second lens 32 may be disposed on both the optical surfaces of the first lens 31.

There is no particular limitation on the method for producing the hybrid lens 30, and known techniques may be adopted. For example, the hybrid lens 30 may be produced as follows. After the first lens 31 as an example of a glass lens is molded by lens polishing, injection molding, press molding, or the like, the composite material 100 is filled in a mold having a shape corresponding to the second lens 32, and the first lens 31 is placed onto the composite material 100 so that the composite material 100 is pressed and extended to a predetermined thickness. Then, for example, an energy ray such as an ultraviolet ray is applied toward the top of the first lens 31 to cure the composite material 100, thereby obtaining the hybrid lens 30 as an example of a hybrid optical element in which the second lens 32 is disposed on the optical surface of the first lens 31.

As described above, Embodiments 1 to 2 have been described as examples of art disclosed in the present application. However, the art in the present disclosure is not limited to these embodiments. It is understood that various modifications, replacements, additions, omissions, and the like have been performed in these embodiments to give optional embodiments, and the art in the present disclosure can be applied to the optional embodiments.

Hereinafter, examples according to the embodiments of the present disclosure, and comparative examples are described. However, the present disclosure is not limited to these examples.

In Examples 1 to 14, the thickness of the shell was varied by varying the ratio of an organic metal complex (a fatty acid salt solution containing the material of the shell) to the material of the core.

### EXAMPLE 1

SiO₂ and Y₂O₃ were prepared as materials of the core and the shell, respectively. For 1.0 g of SiO₂ fine particles having a specific surface area of 200 m²/g, 0.05 g of a fatty acid salt (octylate, naphthenate, acetylacetone metal complex) solution containing Y₂O₃ and 10 g of a dilute solution (xylene, toluene, ethyl acetate, methanol) were used. The ratio of Y₂O₃ to SiO₂ was 5% by weight. After the fine particles and the solutions were mixed and stirred at room temperature, supernatant liquid was removed by a centrifuge, and a resultant solid content was dried. Then, the solid content was subjected to heat treatment for 30 minutes at 400° C. in the atmosphere, thereby obtaining inorganic fine particles.

The inorganic fine particles thus obtained were observed. It was confirmed that the inorganic fine particles have the core-shell structure as shown in FIG. 6 in which the surface of each SiO₂ particle as the core is densely covered with Y₂O₃ fine particles finer than the SiO₂ particle.

A slurry containing the obtained inorganic fine particles was mixed with a ultraviolet curable acrylate monomer (trade name “M-8060”, manufactured by Toagosei Co., Ltd.) and a polymerization initiator (trade name “Irgacure 754”, manufactured by BASF Societas Europaea.), and the solvent was removed from the mixture under vacuum. The resultant mixture was irradiated with an ultraviolet ray and cured. Thus, a composite material of Example 1 was obtained. The content of the inorganic fine particles in the composite material was 5% by weight.

### EXAMPLE 2

Inorganic fine particles were obtained in the same manner as Example 1 except that the amount of the fatty acid salt solution containing Y₂O₃ was changed to 0.15 g and the ratio of Y₂O₃ to SiO₂ was set to 15% by weight in Example 1. A composite material of Example 2 was obtained in the same manner as Example 1 using the obtained inorganic fine particles. The content of the inorganic fine particles in the composite material was 5% by weight.

### EXAMPLE 3

Inorganic fine particles were obtained in the same manner as Example 1 except that the material of the shell was changed to ZnO and the ratio of ZnO to SiO₂ was set to 5% by weight in Example 1. A composite material of Example 3 was obtained in the same manner as Example 1 using the inorganic fine particles. The content of the inorganic fine particles in the composite material was 5% by weight.

### EXAMPLE 4

Inorganic fine particles were obtained in the same manner as Example 3 except that the amount of the fatty acid salt solution containing ZnO was changed to 0.15 g and the ratio of ZnO to SiO₂ was set to 15% by weight in Example 3. A composite material of Example 4 was obtained in the same manner as Example 1 using the inorganic fine particles. The content of the inorganic fine particles in the composite material was 5% by weight.

### EXAMPLE 5

Inorganic fine particles were obtained in the same manner as Example 1 except that the material of the shell was changed to TiO₂ and the ratio of TiO₂ to SiO₂ was set to 5% by weight in Example 1. A composite material of Example 5 was obtained in the same manner as Example 1 using the inorganic fine particles. The content of the inorganic fine particles in the composite material was 5% by weight.

### EXAMPLE 6

Inorganic fine particles were obtained in the same manner as Example 5 except that the amount of the fatty acid salt solution containing TiO₂ was changed to 0.15 g and the ratio of TiO₂ to SiO₂ was set to 15% by weight in Example 5. A composite material of Example 6 was obtained in the same manner as Example 1 using the inorganic fine particles. The content of the inorganic fine particles in the composite material was 5% by weight.

### EXAMPLE 7

Inorganic fine particles were obtained in the same manner as Example 1 except that the material of the shell was changed to ITO and the ratio of ITO to SiO₂ was set to 5% by weight in Example 1. A composite material of Example 7 was obtained in the same manner as Example 1 using the inorganic fine particles. The content of the inorganic fine particles in the composite material was 5% by weight.

### EXAMPLE 8

Inorganic fine particles were obtained in the same manner as Example 7 except that the amount of the fatty acid salt solution containing ITO was changed to 0.15 g and the ratio of ITO to SiO₂ was set to 15% by weight in Example 7. A composite material of Example 8 was obtained in the same manner as Example 1 using the inorganic fine particles. The content of the inorganic fine particles in the composite material was 5% by weight.

### EXAMPLE 9

Inorganic fine particles were obtained in the same manner as Example 1 except that the material of the core was changed to ZnO fine particles having a specific surface area of 100 m²/g and the ratio of Y₂O₃ to ZnO was set to 5% by weight in Example 1. A composite material of Example 9 was obtained in the same manner as Example 1 using the inorganic fine particles. The content of the inorganic fine particles in the composite material was 5% by weight.

### EXAMPLE 10

Inorganic fine particles were obtained in the same manner as Example 9 except that the amount of the fatty acid salt solution containing Y₂O₃ was changed to 0.15 g and the ratio of Y₂O₃ to ZnO was set to 15% by weight in Example 9. A composite material of Example 10 was obtained in the same manner as Example 1 using the inorganic fine particles. The content of the inorganic fine particles in the composite material was 5% by weight.

### EXAMPLE 11

Inorganic fine particles were obtained in the same manner as Example 9 except that the material of the shell was changed to TiO₂ and the ratio of TiO₂ to ZnO was set to 5% by weight in Example 9. A composite material of Example 11 was obtained in the same manner as Example 1 using the inorganic fine particles. The content of the inorganic fine particles in the composite material was 5% by weight.

### EXAMPLE 12

Inorganic fine particles were obtained in the same manner as Example 11 except that the amount of the fatty acid salt solution containing TiO₂ was changed to 0.15 g and the ratio of TiO₂ to ZnO was set to 15% by weight in Example 11. A composite material of Example 12 was obtained in the same manner as Example 1 using the inorganic fine particles. The content of the inorganic fine particles in the composite material was 5% by weight.

### EXAMPLE 13

Inorganic fine particles were obtained in the same manner as Example 9 except that the material of the shell was changed to ITO and the ratio of ITO to ZnO was set to 5% by weight in Example 9. A composite material of Example 13 was obtained in the same manner as Example 1 using the inorganic fine particles. The content of the inorganic fine particles in the composite material was 5% by weight.

### EXAMPLE 14

Inorganic fine particles were obtained in the same manner as Example 13 except that the amount of the fatty acid salt solution containing ITO was changed to 0.15 g and the ratio of ITO to ZnO was set to 15% by weight in Example 13. A composite material of Example 14 was obtained in the same manner as Example 1 using the inorganic fine particles. The content of the inorganic fine particles in the composite material was 5% by weight.

### COMPARATIVE EXAMPLE 1

A mixture of the ultraviolet curable acrylate monomer (trade name “M-8060”, manufactured by Toagosei Co., Ltd.) and the polymerization initiator (trade name “Irgacure 754”, manufactured by BASF Societas Europaea.) was irradiated with an ultraviolet ray and cured, thereby providing a material of Comparative Example 1.

### COMPARATIVE EXAMPLE 2

A mixture of SiO₂ fine particles, the ultraviolet curable acrylate monomer (trade name “M-8060”, manufactured by Toagosei Co., Ltd.), and the polymerization initiator (trade name “Irgacure 754”, manufactured by BASF Societas Europaea.) was irradiated with an ultraviolet ray and cured, thereby providing a composite material of Comparative Example 2. The content of the SiO₂ fine particles in the composite material was 5% by weight.

### COMPARATIVE EXAMPLE 3

A mixture of ZnO fine particles, the ultraviolet curable acrylate monomer (trade name “M-8060”, manufactured by Toagosei Co., Ltd.), and the polymerization initiator (trade name “Irgacure 754”, manufactured by BASF Societas Europaea.) was irradiated with an ultraviolet ray and cured, thereby providing a composite material of Comparative Example 3. The content of the ZnO fine particles in the composite material was 5% by weight.

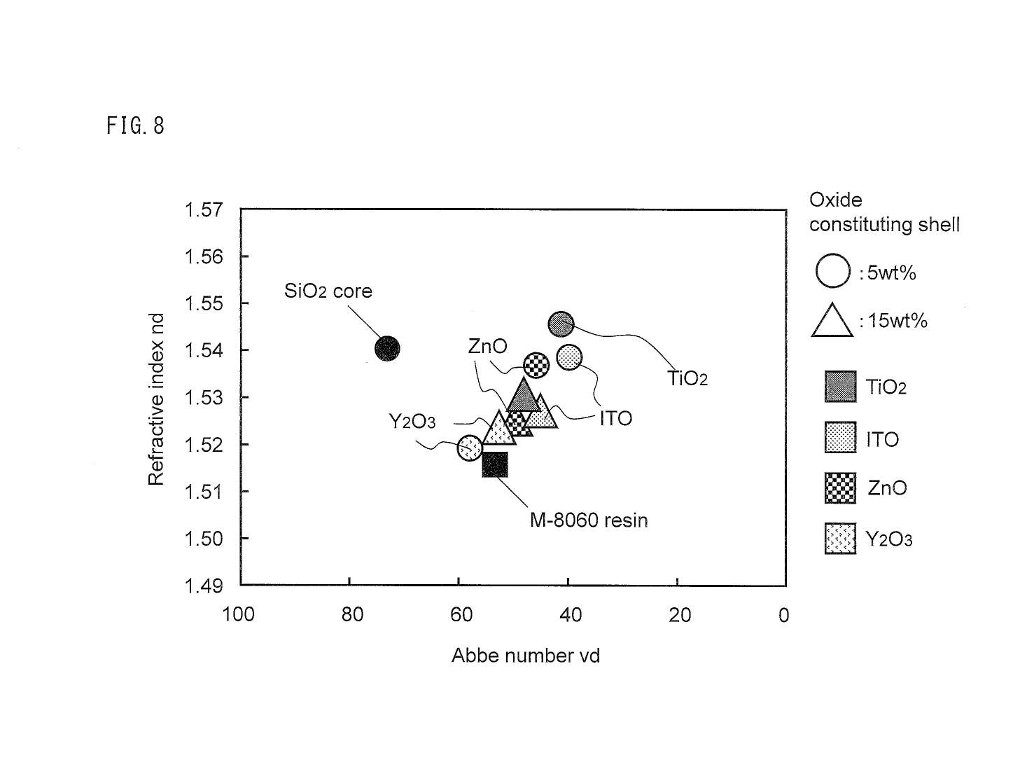

The materials of Examples 1 to 14 and Comparative Examples 1 to 3 were subjected to measurement of refractive indices to the g-line, the F-line, the d-line, and the C-line by using a precision refractometer (KPR-200 manufactured by Shimadzu Device Corporation), and the Abbe numbers νd and the partial dispersion ratios PgF were calculated according to the formulae (1) and (2), respectively. FIGS. 8 to 11 show the results.

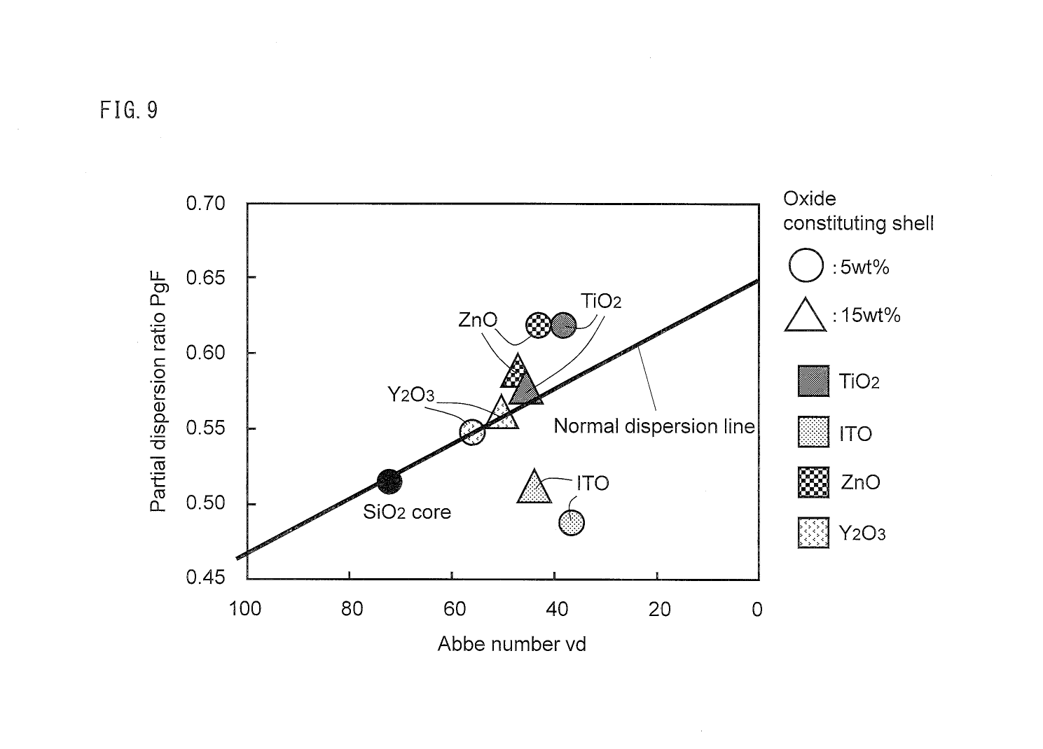

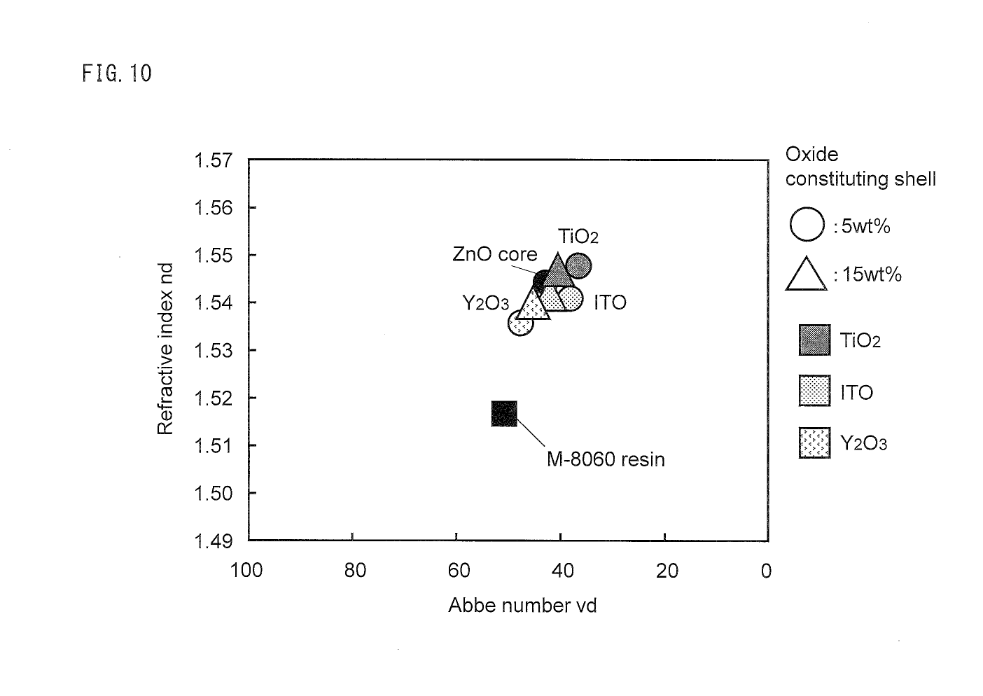

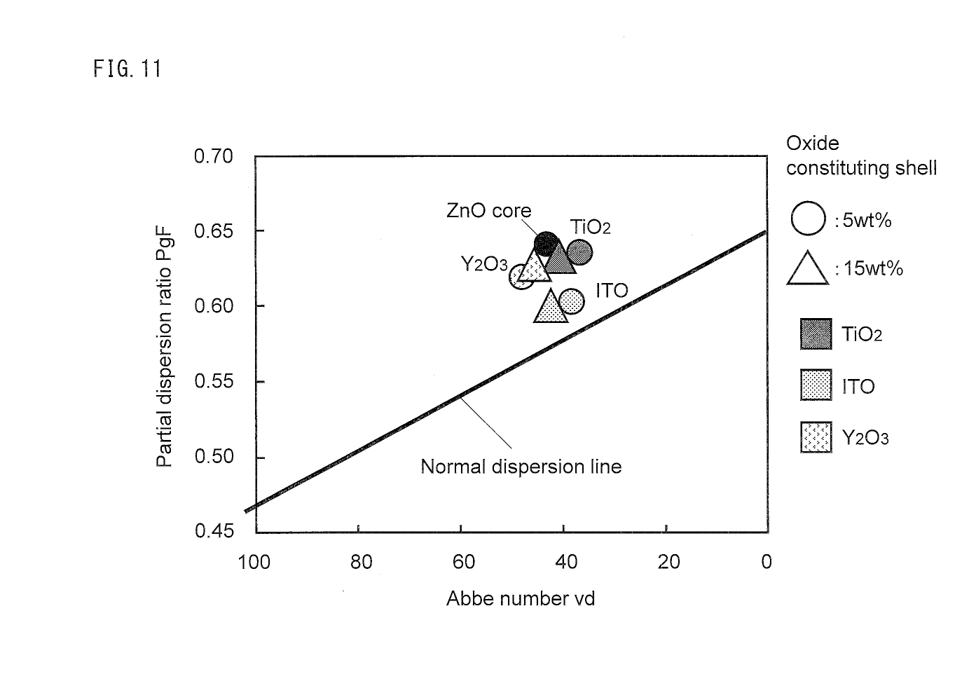

FIG. 8 shows plots showing the relationship between the refractive indices and the Abbe numbers of various materials according to Examples 1 to 8 and Comparative Examples 1 and 2. FIG. 9 shows plots showing the relationship between the partial dispersion ratios and the Abbe numbers of various materials according to Examples 1 to 8 and Comparative Examples 1 and 2, and a normal dispersion line. FIG. 10 shows plots showing the relationship between the refractive indices and the Abbe numbers of various materials according to Examples 9 to 14 and Comparative Examples 1 and 3. FIG. 11 shows plots showing the relationship between the partial dispersion ratios and the Abbe numbers of various materials according to Examples 9 to 14 and Comparative Examples 1 and 3, and a normal dispersion line.

As shown in FIGS. 8 to 11, the composite material (optical material) according to each of Examples 1 to 14 is influenced by the optical properties of the shell of the inorganic fine particles having the core-shell structure, and allows free control of its optical constants in a wide range, as compared to the materials of Comparative Examples using the inorganic fine particles having only cores, i.e., having no shells. Therefore, it is understood that a composite material obtained by dispersing inorganic fine particles having a core-shell structure in a resin material has excellent optical properties, i.e., low dispersion and great anomalous dispersion property.

The present disclosure is favorably applicable to optical elements such as lenses, prisms, optical filters, diffractive optical elements, and the like.

As described above, embodiments have been described as examples of art in the present disclosure. Thus, the attached drawings and detailed description have been provided.

Therefore, in order to illustrate the art, not only essential elements for solving the problems but also elements that are not necessary for solving the problems may be included in elements appearing in the attached drawings or in the detailed description. Therefore, such unnecessary elements should not be immediately determined as necessary elements because of their presence in the attached drawings or in the detailed description.

Further, since the embodiments described above are merely examples of the art in the present disclosure, it is understood that various modifications, replacements, additions, omissions, and the like can be performed in the scope of the claims or in an equivalent scope thereof.

What is claimed is:

1. An optical material comprising a resin material and inorganic fine particles dispersed in the resin material, wherein
each of the inorganic fine particles has a core and a shell formed so as to cover a part of a surface of the core,
the core is formed of an oxide of at least one selected from Si, Ti, Zn, Al, B, Y, Mg, Ba, Ca, Sr, Ni, Cu, In, and Sn,
the shell is formed of an oxide of at least one selected from Si, Ti, Zn, Al, B, Y, Mg, Ba, Ca, Sr, Ni, Cu, In, and Sn, the oxide forming the shell being different from the oxide forming the core,
a particle diameter of the oxide forming the shell is smaller than a particle diameter of the oxide forming the core, and
the shell is formed as crystalline fine particles.

2. An optical element formed of the optical material as claimed in claim 1.

3. A hybrid optical element comprising a first optical element and a second optical element disposed on an optical surface of the first optical element, wherein
the second optical element is an optical element formed of the optical material as claimed in claim 1.
